(19) United States
(12) Patent Application Publication
(10) Pub. No.: US 2009/0172131 A1
(43) Pub. Date: Jul. 2, 2009

(54) Emergency Information System

(76) Inventor: Paul C. Sullivan, North Tonawanda, NY (US)

Correspondence Address: Vincent G. Lo Tempio, Suite 1002, 69 Delaware Avenue, Buffalo, NY, 14202, US

(21) Appl. No.: 12/344,358

(22) Filed: Dec. 26, 2008

Related U.S. Application Data
(60) Provisional application No. 61/009,644, filed on Dec. 28, 2007.

(51) Int. Cl. G06F 15/16

(52) U.S. Cl. 709/219

(57) ABSTRACT

A method and system for intelligently detecting an emergency situation through Public Safety Answering Point (PSAP) notification and providing first responders with vital information to respond and mitigate the emergency situations comprising the following steps: acquiring subscriber information; storing the subscriber information electronically within an information company's secure server; linking the server with a communication device of the PSAP; communicating to the server from the PSAP that an emergency situation has occurred at a specific location when an emergency is reported to the PSAP; searching the server for the subscriber information that matches with the emergency location and sending the matched subscriber information from the server to an appropriate first responder.

This application claims priority of U.S. Provisional Patent Application of Paul C. Sullivan, Ser. No. 61/009,644 for “SECURITY SYSTEM, filed on Dec. 28, 2007.

### BACKGROUND OF THE INVENTION

1. Field of the Invention

This Patent application relates to a computer-based method and system for storing and retrieving tactical information pertaining to a site during crisis situations.

2. Background

Several systems have been invented to facilitate providing critical information to emergency response personnel during an emergency situation. For example U.S. Pat. No. 6,600,812 issued to Gentillin and North discloses a subscriber based emergency response system. In this system, a subscriber supplies input data to the system provider, as well as third party sources of information. The subscriber then registers a series of phone numbers with the system provider. When an emergency is reported to a Public Safety Answering Point (PSAP) using one of these registered numbers, a signal is sent to the system provider. The system provider then locates user supplied information and requests information from listed third party sources. Once all of this information is collected, it is then sent as a packet to the PSAP operator. The operator then reviews the information and passes what he or she feels to be relevant data on to the first responders in the field responding to the emergency. Unfortunately, this system suffers from a number of drawbacks. First, data retrieval is dependent on the phone number used to report the emergency. If this number is not registered the system or not physically located at the emergency, any information given to the PSAP by the system provider would be of questionable use. Moreover, in case of a fire, a family will likely flee their home before calling 911, and if they have not subscribed additional phone numbers, their stored information will not be available. Second, data interpretation and subsequent forwarding to on-site emergency personal is dependent on the understanding and training of the PSAP operator. This training is specific to the invention and is in addition to the standard PSAP training, increasing cost and training time. Lastly, the packet of information may contain superfluous information delaying the transmission of critical data to the first responders.

A second approach to assist emergency personnel is disclosed in U.S. Pat. No. 6,721,396 issued to Chin, et al. This system allows a subscriber to input emergency/health information with the subscription service. As a subscriber dials 911 to report an-emergency to a PSAP, the inputted information is packeted within the call and sent to the PSAP. Again, this system suffers some significant drawbacks. Chiefly, this system relies on the phone number of the phone used to report the emergency. If an unsubscribed phone is used, no information is sent. Secondly, any information sent is dependent on what was inputted by the subscriber and may be incomplete, inaccurate, or unnecessary depending on the type of emergency reported.

A third system is described in U.S. Pat. No. 7,134,088 issued to Larsen. Although useful to emergency first responders, this system is designed predominantly for tactical analysis in handling an emergency situation. This system uses a complex computer based graphic user interface to display information stored on the computer's hard drive or on a CD-ROM. This system is displays multiple windows of information on the screen of the user interface with further information filed under additional pop up headings. However, this system is likely too complex and requires sophisticated computer equipment making it impractical and unavailable to a large number of first responders answering routine emergency calls.

Thus it is readily apparent that there is a long felt need for an emergency response service which quickly and efficiently and without human intervention transmits vital information directly to first responders without necessitating a specific phone number be used to report the emergency.

### SUMMARY OF THE INVENTION

It is accordingly a primary object of the present invention to provide a system and method to supply first responders with vital information for enhancing their performance when responding to emergency situations. The method consists of the following steps: collecting subscriber information, storing this information on a server, and disseminating this information during an emergency. These steps will be further described in the following paragraphs.

An information company obtains vital information from a property owner (commercial or residential). The vital information is the type of information that first responders would benefit from in emergency situations. Examples of vital information are as follows: age and number of inhabitants of a location, medical history of occupants, the general layout of the structure, the number of bedrooms, location of hazardous materials, gas and electric lines and storage tanks, electrical panel, natural gas meter and shutoff, garden tractor or gasoline powered lawn mower, gasoline powered recreational vehicles, gasoline storage containers, oil, lubricants, pressurized containers, i.e. MAPP, welding supplies, garden chemicals i.e. fertilizer, herbicides, insecticides, swimming pool chemicals, firearms and ammunition.

The vital information is stored electronically within a secure server (“the server”). The server receives information from a PSAP when an emergency occurs. When the PSAP dispatcher enters the call location and description, and transmits the information to first responders, that information is simultaneously electronically forwarded to the server using the same process as notification for first responders.

The server sends vital information to the appropriate first responders. (Examples of how the information is sent and received by the emergency first responders are as follows: to a printer at the local fire hall, to cell phones, smart phones, Blackberries, and onboard computers and the like). The emergency first responders use the travel time to the designated property to assess and prepare to deal with the emergency situation.

Additional objects and advantages will become apparent and a more thorough and comprehensive understanding may be had from the following description and claims taken in conjunction with the accompanying drawings forming a part of this specification.

### BRIEF DESCRIPTION OF THE DRAWINGS

The present invention and the manner in which it may be practiced is further illustrated with reference to the accompanying drawings wherein:

FIG. 1 is a flow chart of the method of an emergency service call received by a PSAP and initiation of the present invention.

FIG. 2 is a functional block diagram representation of one example of a system in accordance with the invention.

FIG. 3 is a functional block diagram representation of an information server in accordance with the invention.

### DETAILED DESCRIPTION OF THE INVENTION

At the outset, it should be clearly understood that like reference numerals are intended to identify the same structural elements, portions, or surfaces consistently through out the several drawing figures, as may be further described or explained by the entire written specification of which this detailed description is an integral part. The drawings are intended to be read together with the specification and are to be construed as a portion of the entire “written description” of this invention as required by 35 U.S.C. §112.

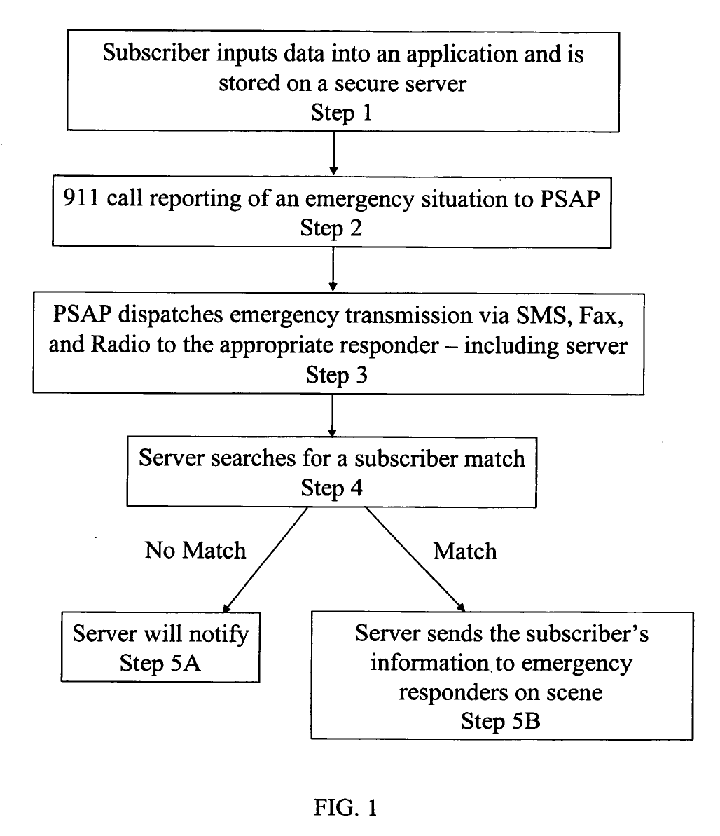

Adverting now to the drawings, a preferred embodiment of the present invention is generally shown by FIG. 1, including the steps: subscriber inputs data (vital information) into an application and is stored on a secure server (Step 1). The vital information is the type of information that first responders would benefit from in emergency situations. Examples of vital information are as follows: age and number of inhabitants of a location, medical history of occupants, the general layout of the structure, the number of bedrooms, location of hazardous materials, gas and electric lines and storage tanks, electrical panel, natural gas meter and shutoff, garden tractor or gasoline powered lawn mower, gasoline powered recreational vehicles, gasoline storage containers, oil, lubricants, pressurized containers, i.e. MAPP, welding supplies, garden chemicals i.e. fertilizer, herbicides, insecticides, swimming pool chemicals, firearms and ammunition. In step 2, a 911 call reporting of an emergency situation to Public Safety Answering Point (PSAP). In step 3 PSAP dispatches emergency transmission via Short Messaging Service (SMS), fax, and radio to the appropriate responder and to the server. In step 4, SMS transmission triggers a server search for a subscriber match. If there is no match, server will notify first responders that there is no match (Step 5A), or if there is a match, server sends the subscriber's information to emergency responders on scene (Step 5B).

### Example System Architecture

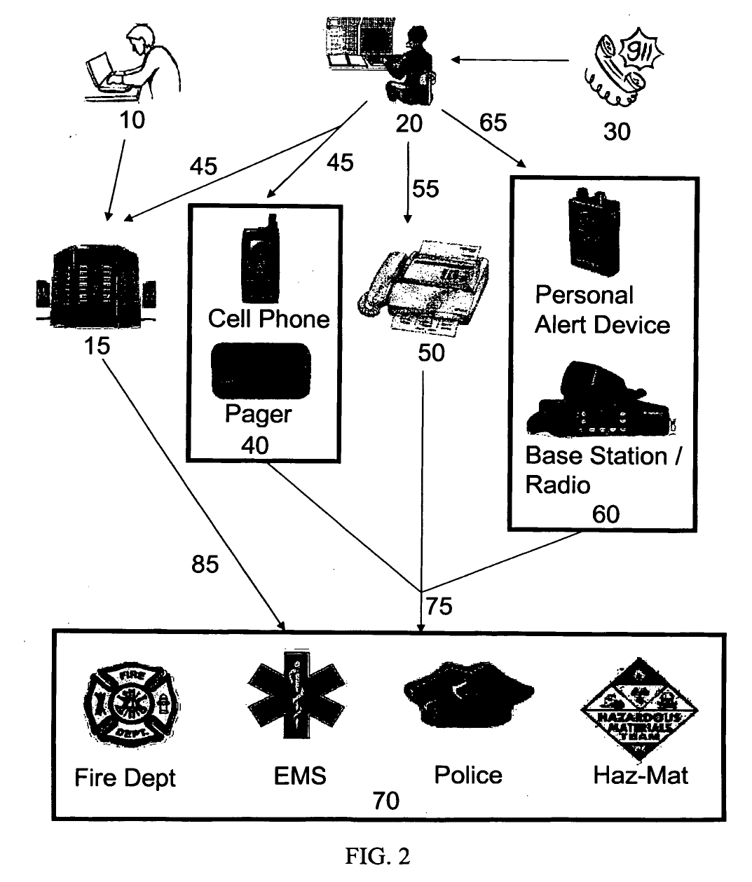

In a particular embodiment, this is a system whereby emergency first responders are provided vital information in the event of an emergency at a location. This system architecture is shown in FIG. 2. The inhabitants of a residence or the owners of a business 10 enter the information into the system's server 15. The information includes, for example: a diagram of the physical nature of the property; the names, ages, pictures and if applicable the limitations, medical or physical of the inhabitants; schematically represented positions of services, i.e. electrical and gas and storage areas of hazardous substances, i.e. gasoline, propane tanks, garden fertilizer.

In the event of an emergency at a location, an emergency 911 call 30 is placed to the local PSAP 20. This call can come from anybody and is not limited to the subscriber or the subscriber's pre-selected telephone numbers. The PSAP dispatcher 20 will then dispatch information in a variety of ways: SMS transmission 45 to a text message receiver 40, such as a cell phone, or an alpha-numeric pager; fax transmission 55 to first responder fax machine 50; and radio transmission 65 to radio devices 60, such as a personal alert device or base station/radio. This transmission will include a) the street address, and b) a description of the emergency. In the preferred embodiment, SMS transmission 45 which is sent to and activates server 15. However, Server 15 can also be activated using other means, such as radio transmission to text transcription, and can be customized according to each PSAP's available information dissemination means. Once server 15 receives the PSAP transmission 45, the computer program housed in the server searches for a subscriber match. If there is a match, server sends the subscriber's information to emergency responders on scene. If there is no match, server will notify responders that there is no information in the database.

As shown in FIG. 2, depending on the type of receiver possessed by the emergency first responder, the corresponding PSAP information 75 and server information 85 (if there is a subscriber match) is electronically disseminated to any first responder 70 responsible for that location: for example members of the responsible fire and police departments, EMS members, or Haz-Mat team. In the preferred embodiment, server 15 will forward multiple reports (medical, fire, police) 85 with links to a web browser to emergency personnel. This web browser is secured by username and password and allows multiple receiving units to be used. It is important to note that information from the system's server is transmitted directly to the emergency first responders and does not need to be interpreted and retransmitted by the PSAP dispatcher. No human intervention is needed in the present invention to send subscriber information to emergency personnel. This negates the need for trained operators and increases speed of information transmission and reduces costs. Additionally, information is based on physical location and not specific phone numbers, and information from third-party servers is not included further increasing speed and accuracy. These benefits allow first responders to use their time en route to focus on the relevant subscriber information which familiarizes them with what they will encounter at the location. The benefit to insurers is limitation of loss. The benefit to first responders is their own safety and increased ability to assist the inhabitants of the location.

In addition, when the use of location cannot be used to provide first responders with additional information, one feature of the program allows for a search feature based upon the subscriber's name, business, cell phone, etc. The search process is much slower than the automatic transmission of the location based process, but allows for a subscriber to be found in the system if not located at their residence.

The system will also allow for businesses, colleges and universities, apartment complexes, and other large facilities to enroll members of their community into the system. In the event of an emergency, relevant information will be transmitted automatically and the system will allow a first responder to search for a person's medical information in a search that is already filtered to that business or college, etc.

### Data Structures

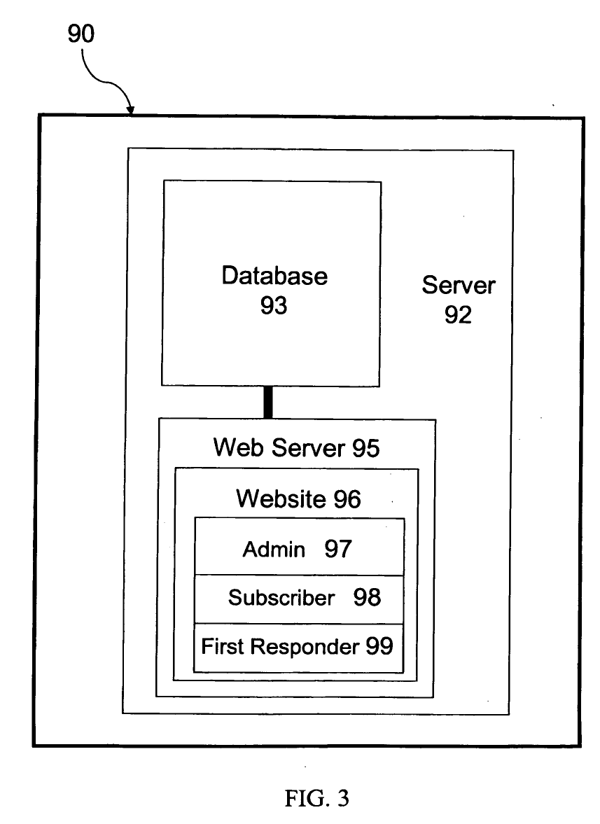

In the preferred embodiment, the information system is a Software as a Service (SAS) and is shown schematically in FIG. 3. The service requires no human intervention in operation. Once the data is inputted onto the server no human intervention is needed to disseminate the information to the first responders. In operation the SAS is housed at a data center 90. The logical components at the data center are the database 93, which resides on a server 92, and a web server 95 for web services and web pages. The system is scalable by adding as many servers and databases as required.

All the data in the system is collected into the database on an ad hoc basis through the Internet or the World Wide Web. In the preferred embodiment, data is gathered through a website 96 housed on web server 95, however, subscriber information can be inputted using any acceptable means such as using paper forms or via telephone. Preferably, data is inputted using specific form fields or drop-down menus minimizing the amount of written information stored in the subscriber's record. This data collection approach efficiently and searchably displays relevant data to first responders without necessitating much reading by the first responders as they may not have the time or attention sufficient to filter large written fields to find the relevant information. Data is entered through the subscriber's webpage 98, first responder's webpage 99, and the admin webpage 97 by registered subscribers, registered first responders, and information company personnel, respectively. Each section of the website is available through Secure Socket Layer (SSL) so as to be secure with no possibility of data loss. All data are kept private behind a firewall and encrypted through the stream as entered. The subscriber enters specific, vital information on the system's website. The subscriber receives a confirmation that the information is in the system. The system resolves the Emergency Response districts for the subscriber's location. In another embodiment, Interactive Voice Response (IVR) is used for inputting outgoing and incoming data. In this embodiment, subscriber information is inputted as a voice command instead of keyboard stroke commands.

Individual first responders become registered users of the system by entering their contact information. Each first responder has several methods of communication with the information company server. Although, in the preferred embodiment of the present invention the communication is sent by an internet connected computer, a personal data assistant, cell phones with text messaging and/or cell phones with web capability, any form of communication suitable to quickly deliver this information can be used. This information is username and password protected so that only the individual responder can modify his/her own information. Periodically, tests are conducted by the system to confirm the communication link between the system and the PSAP districts.

In the case of an emergency at a registered location, the information company receives an indication of an emergency from the PSAP (i.e. 911 district that receives the notification of that emergency). This indication comes to the information company via an application provided to the 911 district. The information that the information company receives from the PSAP includes the location and the nature of the emergency, i.e. fire, medical, or police. The system locates the place of the emergency and sends the appropriate information from the server to each registered first responder responsible for that location. This information consists of multiple reports. Examples of reports are fire, medical, police and hazmat reports. This information is transmitted through the Internet and the World Wide Web and is available to registered first responders on a secure webpage.

Although the invention as been described with reference to certain preferred embodiments, it will be appreciated by those skilled in the art that modifications and variations may be made without departing from the spirit and scope of the invention. It should be understood that applicant does not intend to be limited to the particular details described above and illustrated in the accompanying drawings. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed:

1. A method for intelligently detecting an emergency situation through Public Safety Answering Point (PSAP) notification and providing first responders with vital information to respond and mitigate said emergency situations comprising the following steps:
acquiring subscriber information;
storing said subscriber information electronically within an information company's secure server;
linking said server with a communication device of said PSAP;
communicating to said server from said PSAP that an emergency situation has occurred at a specific location when an emergency is reported to said PSAP;
searching said server for said subscriber information that matches with said emergency location; and
sending said matched subscriber information from said server to an appropriate first responder.

2. The method of claim 1 wherein said communicating to said server is through a short messaging service (SMS) transmission sent from the PSAP communication device to said server when said PSAP communication device sends said SMS message to said first responders.

3. The method of claim 2 wherein said communication comprises: an address of said location; and a description of said emergency.

4. The method of claim 1 wherein said subscriber information is electronically acquired by said information company through a website application.

5. The method of claim 1 wherein said subscriber information is electronically acquired by said information company through an interactive voice response application.

6. The method of claim 1 wherein said subscriber information sent to first responders comprises multiple reports.

7. The method of claim 6 wherein said multiple reports comprises:
reports containing information useful to medical personnel;
reports containing information useful to fire personnel; and
reports containing information useful to police personnel.

8. The method of claim 7 wherein said reports are sent through the internet and are accessible by link on a web site.

9. The method of claim 8 wherein said reports are username and password protected enabling multiple receiving technologies to have simultaneous access to said reports.

10. An emergency response collection system for intelligently detecting an emergency situation through Public Safety Answering Point (PSAP) notification and providing first responders with subscriber information to respond to said emergency situations-comprising:
a database residing on a secure server;
a first interface for subscribers to input said subscriber information into said database;
a second interface for first responder agencies to input emergency responder information into said database;
a third interface for said server to communicate with at least one PSAP system; and
a fourth interface for said server to communicate with said first-responder.

11. The system in claim 10 wherein said first interface for subscribers comprises a website housed on a web server.

12. The system in claim 10 wherein said second interface comprises a website housed on a web server.

13. The system in claim 10 wherein said subscriber website includes an information questionnaire with specific form fields.

14. The system in claim 10 wherein said first interface and said second interface are electronically secured.

15. The system in claim 14 wherein said first interface and said second interface are electronically secured by fire wall and encryption.
